(19) United States
(12) Patent Application Publication
(10) Pub. No.: US 2007/0175725 A1
(43) Pub. Date: Aug. 2, 2007

(54) Multiplate wet clutch

(75) Inventor: Manabu Sawayanagi, Fukuroi-shi (JP)

Correspondence Address: SUGHRUE-265550, 2100 PENNSYLVANIA AVE. NW, WASHINGTON, DC, 20037-3213, US

(73) Assignee: NSK-WARNER KABUSHIKI KAISHA, Shinagawa-ku (JP)

(21) Appl. No.: 11/700,078

(22) Filed: Jan. 31, 2007

(30) Foreign Application Priority Data
Jan. 31, 2006 (JP) 2006-023114

(51) Int. Cl. F16D 13/52

(52) U.S. Cl. 192/70.2; 192/85 AA

(57) ABSTRACT

A multiplate wet clutch has a first clutch portion comprising at least a first engaging element and a first engaged element, which are alternately arranged, a second clutch portion comprising at least a second engaging element and a second engaged element and a piston which fastens and releases engagements between the first and second engaging elements and the first and second engaged elements. The piston presses the first and the second clutch portions.

### BACKGROUND OF THE INVENTION

1. Field of the Invention

The present invention relates to a multiplate wet clutch (friction engagement apparatus) used as a clutch or a brake for the automatic transmission of a vehicle and, in particular, relates to an improvement of a pressing structure of a friction plate.

2. Description of Related Art

In general, the multiplate wet clutch is configured in a manner that friction plates and separator plates are disposed alternatively between a drum and a hub of a clutch or a brake, whereby the engagement and the release of the clutch are performed by pressing and releasing of a clutch piston.

In such the multiplate wet clutch, at the beginning of the clutch engagement or the brake pressuring, a fine control for relaxing a shock and for controlling a slipping action is required.

In order to satisfy such a requirement, a Japanese Patent Unexamined Publication JP-A-7-042757 discloses a configuration that one of friction elements is divided along the radial direction thereof and the abutment start points between the divided portions of the one friction element and the other of the friction elements are differentiated.

However, the clutch disclosed in the JP-A-7-042757 is configured as a so-called twin clutch in which two cutch pistons are disposed on the same axis of a housing. According to this type of the clutch, since a large space is required in both the axial and radial directions, it could not necessarily satisfy the requirements of the reduction of the size of the clutch and also the cost reduction resulted from the reduction of the number of parts of the clutch.

### SUMMARY OF THE INVENTION

Accordingly, an object of the invention is to provide a multiplate wet clutch which is small in a shock at the time of the clutch engagement, which can reduce the size in the axial and radial directions thereof and also which reduces the cost thereof by reducing the number of parts.

In order to attain the aforesaid object, according to the first aspect of the present invention, there is provided a multiplate wet clutch comprising:

a first clutch portion comprising at least a first engaging element and a first engaged element, which are alternately arranged;

a second clutch portion comprising at least a second engaging element and a second engaged element; and

a piston which fastens and releases engagements between the first and second engaging elements and the first and second engaged elements,

wherein the piston presses the first and the second clutch portions.

According to a second embodiment of the invention, as set forth in the first aspect of the present invention, it is preferable that the second clutch portion is fastened when a pressing force of the piston is equal to or larger than a predetermined load.

According to a third embodiment of the invention, as set forth in the second aspect of the present invention, it is preferable that the multiplate wet clutch further comprising:

a partition member which separates the first clutch portion from the second clutch portion; and

a biasing member which biases the second clutch portion against the partition member with the predetermined load.

According to a fourth aspect of the invention, as set forth in the third aspect of the invention, it is preferable that the biasing member is a coil-spring.

According to a fifth aspect of the invention, as set forth in the third aspect of the invention, it is preferable that the biasing member is a disc spring.

According to a sixth aspect of the invention, as set forth in the third aspect of the invention, it is preferable that the biasing member comprises a plurality of the disc springs, and

the plurality of the disc springs have different spring coefficients, respectively.

According to a seventh aspect of the invention, as set forth in the third aspect of the invention, it is preferable that the first clutch portion is fastened in accordance with the pressing load of the piston, and

the second clutch portion is fastened when the pressing force of the piston is equal to or lager than a biasing force of the biasing member.

According to an eighth aspect of the invention, as set forth in the first aspect of the invention, it is preferable that each of the first clutch portion and the second clutch portion has the first and second engaging elements and first and second engaged elements which have different friction members, having different characteristic, respectively.

The following effects can be attained according to the invention.

Since the first clutch portion and the second clutch portion, which are divided in a functional view point, are provided, the fine control for relaxing a shock and for controlling a slipping operation can be performed at the beginning of the clutch engagement or the brake pressuring.

Since both the first clutch and the second clutch can be fastened by using the single piston, the size of the clutch can be made small in the axial and radial directions and the cost of the clutch can be reduced due to the reduction of the number of parts of the clutch.

When a disc spring is used, since the space of the spring housing portion of the second clutch portion can be made small, the space of the clutch can be made small in the radial direction. When a reaction force of the disc spring is used, a return spring of the piston can be eliminated, advantageously. Further, since a clearance between driven plates (separator plates) is kept, it is effective to reduce drag phenomenon.

Further, since a new housing is not required to develop, and an existent housing can be employed, an additive cost is not required.

### BRIEF DESCRIPTION OF THE DRAWINGS

FIG. 1 is a fragmentary sectional view in the axial direction of a multiplate wet clutch showing the first embodiment of the invention;

FIG. 2 is a front view of the multiplate wet clutch of FIG. 1 when seen from the opened end side of a clutch case;

FIG. 3 is a sectional diagram of the clutch cut along a line A-O-A in FIG. 2;

FIG. 4 is a front view of apart of a friction plate showing the third embodiment of the invention;

FIG. 5 is a front view of apart of a friction plate showing the fourth embodiment of the invention; and

FIG. 6 is a graph showing the relation between a load applied to a piston and a transmission torque in the respective embodiments of the invention.

### DETAILED DESCRIPTION OF EXEMPLARY EMBODIMENTS OF THE INVENTION

### Embodiments

Hereinafter, the invention will be explained in detail. In the drawings, similar parts are shown by the same reference numerals. The embodiments described below are explained exemplarily and do not limit the invention in any meanings.

### First Embodiment

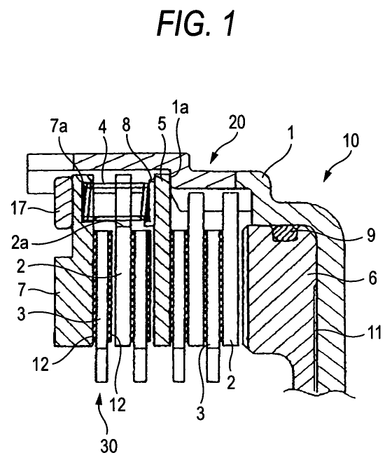

FIG. 1 is a fragmentary sectional view in the axial direction of a multiplate wet clutch 10 showing the first embodiment of the invention.

The multiplate wet clutch 10 is configured by a housing (a clutch case 1) of an almost cylindrical shape which is opened at the axial one end thereof;

a hub (not shown) which is disposed at the inner periphery of the clutch case 1 and relatively rotates around the axis of the housing;

an annular separator plate 2 (engaging element) which is disposed so as to be movable freely in the axial direction at a spline 8 provided at the inner periphery of the clutch case 1; and

an annular friction plate 3 (engaged element) which is disposed so as to be movable freely in the axial direction at a spline (not shown) provided at the outer periphery of the hub and to which a friction member is pasted. A plurality of the separator plates 2 and a plurality of the friction plates 3 are provided therein.

The multiplate wet clutch 10 further includes:

a piston 6 for pressing the separator plates 2 and the friction plates 3 and fastening them to each other;

a backing plate 7 provided at the inner periphery of the clutch case 1 for holding the separator plates 2 and the friction plates 3 at the one ends in the axial direction thereon in a fixed state; and

a retaining ring 17 for holding the backing plate 7.

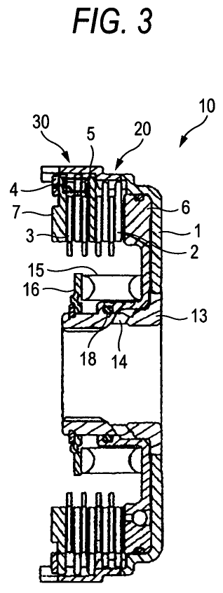

As shown in FIG. 1, the piston 6 is disposed within the closed end of the clutch case 1 so as to be slidable freely in the axial direction. An O-ring 9 is placed between the outer peripheral surface of the piston 6 and the inner peripheral surface of the clutch case 1. Another O-ring 8 (see FIG. 3) is also provided between the inner peripheral surface of the piston 6 and the outer peripheral surface of the shaft portion 13 (see FIG. 3) of the clutch case 1. Thus, a hydraulic chamber 11 in an oil tight state is defined between the inner periphery of the closed end of the clutch case 1 and the piston 6.

A return spring 15 is provided between a stopper 16 fixed to the shaft portion 13 and the piston 6 so as to press the piton 6 toward the clutch case 1 side in a state where the hydraulic pressure has not been applied to the hydraulic chamber 11 yet. Further, the shaft portion 13 is provided with an oil supply port 14 through which oil from an oil supply source (not shown) is supplied to the hydraulic chamber 11.

A friction member 12 having a predetermined friction coefficient is fixed to the both side surfaces of each of the friction plates 3 which is held by the hub so as to freely slide in the axial direction. The friction member 12 may be provided only on the one side surface of the friction plate 3. Further, the hub is provided with a lubricating oil supply port (not shown) penetrating in the radial direction thereof thereby to supply lubricating oil from the inner diameter side to the outer diameter side of the multiplate wet clutch 10.

The clutch potion of the multiplate wet clutch 10 has a first clutch portion 20 disposed on the piston 6 side and a second clutch portion 30 disposed on the backing plate 7 side. The first clutch portion 20 and the second clutch portion 30 are separated to each other by a partition plate 5 held at the inner periphery of the clutch case 1 so as to be movable in the axial direction. The first clutch portion 20 is configured by the two friction plates 3 and the two separator plates 2. The second clutch portion 30 is configured by the two friction plates 3 and the one separator plate 2 disposed therebetween. Of course, each of the numbers of the friction plates and the separator plates is arbitrary and so may be set to another number.

The separator plate 2 of the second clutch portion 30 has holes 2a each provided on the outer diameter side thereof so as to penetrate in the axial direction. A spring 4 penetrates through the hole 2a is held thereon. Although a coil spring is used as the spring 4 in this embodiment, another type of spring may be used in place of the coil spring.

The one end in the axial direction of the spring 4 is held by the holding member 8 provided at the partition plate 5. The other end of the spring is held by a recess portion 7a provided at the backing plate 7. The partition plate 5 is restricted in its movement to the right direction in FIG. 1 by a step portion la of the clutch case 1. The second clutch portion 30 is kept in a non-fastened state by the biasing force of the spring 4 so long as not being applied with the pressing force from the piton 6.

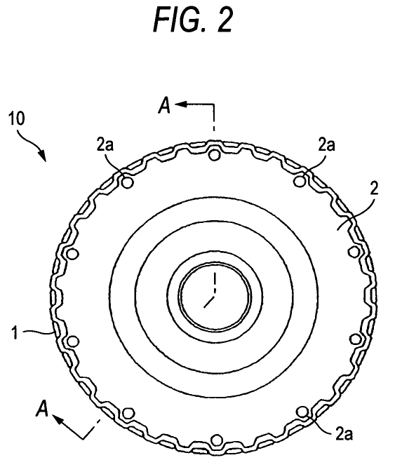

FIG. 2 is a front view of the multiplate wet clutch 10 of FIG. 1 when seen from the opened end side of the clutch case 1. FIG. 3 is a sectional diagram of the clutch cut along a line A-O-A in FIG. 2. In FIG. 2, the backing plate 7 and the retaining ring 17 are omitted. As is clear from FIG. 2, a plurality of the holes 2a, through each of which the spring 4 penetrates, are provided along the circumferential direction of the outer diameter portion of the separator plate 2 with a constant interval. Thus, plurality of the springs 4 are provided in correspondence to the holes 2a.

The multiplate wet clutch 10 configured in this manner fastens and releases the clutch in the following manner. FIG. 1 shows a released state of the clutch where the separator plate 2 and the friction plate 3 contact to each other without being applied any load thereto. In the released state, the piston 6 abuts against the closed end side of the clutch case 1 by the biasing force of the return spring 15.

In order to fasten the clutch in this state, the hydraulic pressure is applied to the hydraulic chamber 11 defined between the piston 6 and the clutch case 1. In accordance with the increase of the hydraulic pressure, the piston 6 moves to the left side with respect to the axial direction in FIG. 1 against the biasing force of the return spring 15 thereby to adhere the separator plates 2 to the friction plates 3, whereby the first clutch portion 20 is fastened.

Next, when the hydraulic pressure increases further, the piston 6 further moves to the left side in FIG. 1 thereby to press entirely the first clutch portion 20 in the fastened state to the partition plate 5. When the piston 6 furthermore moves to the left side in this state, the pressing force of the piston 6 becomes larger than the biasing force of the spring 4, whereby the partition plate 5 is pushed by the piston 6 and so starts to move in the left direction in the figure.

When the partition plate 5 further moves, the partition plate 5 presses the friction plates 3 and the separator plates 2 between the backing plate 7 and the partition plate. As a result, the second clutch portion 30 is also made in the fastened state.

In the aforesaid operation, the force relation among them will be described as follows.

The first clutch portion 20 is applied with a load F1 due to the pressing force of the piston 6 and so placed in a friction engagement state. Supposing that the biasing force of the spring 4 in order to keep the second clutch portion 30 in the released state is F2, the second clutch portion 30 is fastened by the piston 6 when F1 is larger than F2. When F1 is equal to or smaller than F2, although the first clutch portion 20 is fastened, the partition plate 5 does not move, whereby the second clutch portion 30 is kept in a non-fastened state. This relation is also applied to the second and third embodiments described later.

As described above, since the first clutch portion and the second clutch portion, which are divided in a functional view point, are provided, the fine control for relaxing a shock and for controlling a slipping operation can be performed at the beginning of the clutch engagement or the brake pressuring.

Further, since both the first clutch and the second clutch can be fastened by using the single piston, the size of the clutch can be made small in the axial and radial directions and the cost of the clutch can be reduced due to the reduction of the number of parts of the clutch.

### Second Embodiment

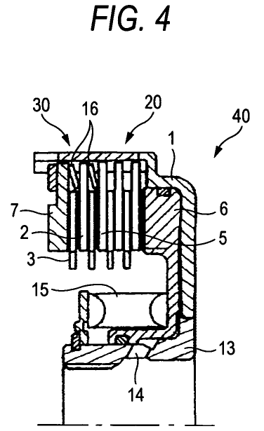

FIG. 4 is a sectional view in the axial direction of a multiplate wet clutch 40 showing the second embodiment of the invention. In this embodiment, a disc spring 16 is used in place of the spring 4 (coil spring) which is used in the first embodiment. A first clutch portion 20 has almost the same configuration as the first embodiment.

A second clutch portion 30 is configured in a manner that the single disc spring 16 is disposed between the two separator plates 2. In this embodiment, the two disc springs 16 are used, whereby the partition plate 5 is pressed to the step portion la by the biasing forces of the disc springs to keep the second clutch portion 30 in a non-fastened state, that is, a released state.

The second embodiment has almost the same configuration as the first embodiment except that the disc spring 16 is used in the second clutch portion 30.

### Third Embodiment

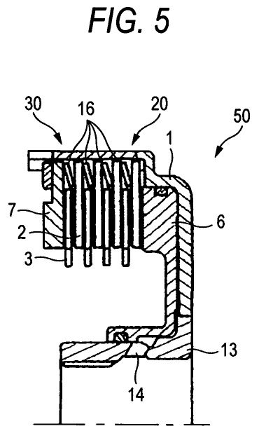

FIG. 5 is a sectional view in the axial direction of a multiplate wet clutch 50 showing the second embodiment of the invention. Like the second embodiment, a disc spring 16 is used in a second clutch portion 30 in this embodiment. However, in this embodiment, the disc spring 16 is also disposed between the separator plates in a first clutch portion 20 in which no spring is used in each of the first and second embodiments.

Since a reaction force of the disc spring 16 provided at the first clutch portion 20 is used, this embodiment eliminates the return spring 15 which is used for restoring the piston 6 to the initial position in the first and second embodiments.

Although the third embodiment does not use the partition plate 5, the effects similar to the first and second embodiments can be obtained by changing the spring constants or the number of the disc springs 16 disposed in the first clutch portion 20 and the second clutch portion 30.

The disc springs 16 used in the second and third embodiments may have the same spring constant or may have different spring constants.

Further, although the single disc spring 16 is provided between the two separator plates 2, a plurality of the disc springs may be provided therebetween.

When the disc springs 16 are used like the second and third embodiments, since the space of the spring housing portion of the second clutch portion 30 can be made small, the space of the clutch can be made small in the radial direction. Further, since a clearance between the driven plates (separator plates) is kept, it is effective to reduce drag phenomenon. Furthermore, since it is not necessary to provide the holes 2a for penetrating the springs 4 therethrough at the separator plate like the first embodiment, the existing separator plate can be used as it is.

Also in the second and third embodiments, since the first clutch portion and the second clutch portion, which are divided in a functional view point, are provided, the fine control for relaxing a shock and for controlling a slipping operation can be performed at the beginning of the clutch engagement or the brake pressuring.

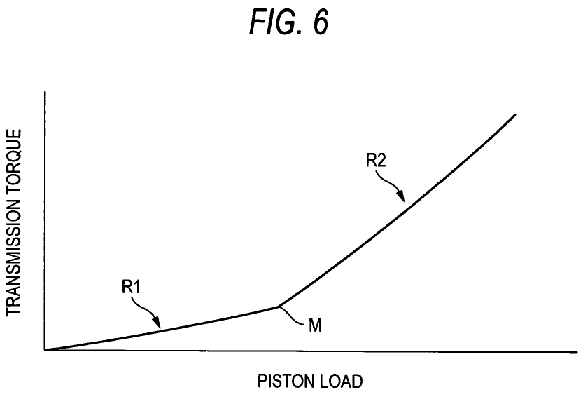

FIG. 6 is a schematic graph showing the relation between a load applied to the piston and a transmission torque according to the embodiments of the invention. The transmission torque increases gradually as the pressing force of the piston 6, that is, a load of the piston increases. The transmission torque changes with a gentle slope and so the increasing rate of the transmission torque is small until the piston load reaches a point M. A region R1 from 0 to the point M where the piston 6 places the first clutch portion 20 in the fastened state and then presses the partition plate 5 represents the engagement initial state of the clutch.

When the transmission torque passes the point M, since the piston 6 places the second clutch portion 30 in the fastened state via the partition plate 5, the sum of the transmission torques of the first clutch portion 20 and the second clutch portion 30 can be obtained. Thus, it will be understood that the slope in a region R2 is larger than the region R1 and so the increasing rate of the transmission torque is larger as compared with the increasing rate of the load of the piston 6 in the region R2.

The number of each of the separator plates and the friction plate constituting the first and second clutch portions is arbitrary and may be increased or reduced in accordance with the capacity of the required transmission torque, of course.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A multiplate wet clutch comprising:
a first clutch portion comprising at least a first engaging element and a first engaged element, which are alternately arranged;
a second clutch portion comprising at least a second engaging element and a second engaged element; and
a piston which fastens and releases engagements between the first and second engaging elements and the first and second engaged elements,
wherein the piston presses the first and the second clutch portions.

2. The multiplate wet clutch according to claim 1, wherein the second clutch portion is fastened when a pressing force of the piston is equal to or larger than a predetermined load.

3. The multiplate wet clutch according to claim 2, further comprising:
a partition member which separates the first clutch portion from the second clutch portion; and
a biasing member which biases the second clutch portion against the partition member with the predetermined load.

4. The multiplate wet clutch according to claim 3, wherein the biasing member is a coil spring.

5. The multiplate wet clutch according to claim 3, wherein the biasing member is a disc spring.

6. The multiplate wet clutch according to claim 3, wherein the biasing member comprises a plurality of the disc springs, and
the plurality of the disc springs have different spring coefficients, respectively.

7. The multiplate wet clutch according to claim 3, wherein the first clutch portion is fastened in accordance with the pressing load of the piston, and
the second clutch portion is fastened when the pressing force of the piston is equal to or lager than a biasing force of the biasing member.

8. The multiplate wet clutch according to claim 1, wherein each of the first clutch portion and the second clutch portion has the first and second engaging elements and first and second engaged elements which have different friction members, having different characteristic, respectively.
